(19) United States
(12) Patent Application Publication
(10) Pub. No.: US 2015/0217294 A1
(43) Pub. Date: Aug. 6, 2015

(54) SEALED CONTAINER AND CELL TRANSFER SYSTEM

(71) Applicant: TOKYO ELECTRON LIMITED, Minato-ku (JP)

(72) Inventor: Akitake TAMURA, Minato-ku (JP)

(73) Assignee: TOKYO ELECTRON LIMITED, Minato-ku (JP)

(21) Appl. No.: 14/610,347

(22) Filed: Jan. 30, 2015

(30) Foreign Application Priority Data
Feb. 3, 2014 (JP) 2014-018521

(51) Int. Cl. B01L 9/00

(52) U.S. Cl. CPC B01L 9/523

(57) ABSTRACT

A sealed container device for hermetically accommodating cells includes a container body having an opening, a lid detachable from the opening of the container body, and a sealing structure positioned in gap formed between the container body and lid when the lid is inserted into the opening of the container body such that the sealing structure maintains sealed condition of the cells in the container body. The container body includes a step and a metal body positioned at the step such that the step is positioned to face peripheral edge of the lid on container-body side, and the lid includes a magnet positioned to face the metal body and a yoke structure movable relative to the magnet between a state where a magnetic circuit is formed between the magnet and the metal body and a state where the magnetic circuit is blocked.

### CROSS-REFERENCE TO RELATED APPLICATIONS

The present application is based upon and claims the benefit of priority to Japanese Patent Application No. 2014-018521, filed Feb. 3, 2014, the entire contents of which are incorporated herein by reference.

### BACKGROUND OF THE INVENTION

1. Field of the Invention

The present invention relates to a sealed container for hermetically accommodating cells, and to a cell transfer system using such a sealed container.

2. Description of Background Art

JP2008-206495A describes a cell cultivation apparatus for cultivating cells in a culture vessel and a carrier case used for transporting the culture vessel between the cell cultivation apparatus and a clean bench. When the opening of the carrier case and the loading port of the cultivation apparatus are positioned to face each other, the door that seals the loading port is opened. Then, a transfer arm inside the cultivation apparatus is operated so that the culture vessel is transferred from the carrier case to the cultivation apparatus.

JP S51-49520A and JP H06-193323A describe a container for hermetically accommodating hazardous substances such as radioactive or toxic substances, and an isolation chamber for safely transferring a hazardous substance from the container while preventing leakage of the hazardous substance to the outside. The lid of the container is a bayonet type and is detachable from the container body. The gap between the container body and the lid is sealed by a sealing member provided for the container, and the gap between the door and the body of the isolation chamber is sealed by a sealing member provided for the chamber body. When the openings of the container and the isolation chamber are positioned to face each other, the container-side sealing member is tightly fitted to the isolation chamber so that the gap between the container body and the isolation chamber is sealed, while the isolation chamber-side sealing member is tightly fitted to the lid so that the gap between the door and the lid is sealed. As a result, when the lid is detached from the container body to transfer a hazardous substance from the container to the isolation chamber, the hazardous substance is prevented from leaking to the outside.

The entire contents of these publications are incorporated herein by reference.

### SUMMARY OF THE INVENTION

According to one aspect of the present invention, a sealed container device for hermetically accommodating cells includes a container body having an opening portion, a lid detachable from the opening portion of the container body, and a sealing structure positioned in a gap formed between the container body and the lid when the lid is inserted into the opening portion of the container body such that the sealing structure maintains a sealed condition of the cells accommodated in the container body. The container body includes a step portion and a metal body positioned at the step portion such that the step portion is positioned to face a peripheral edge portion of the lid on a container-body side, and the lid includes a magnet positioned to face the metal body in the container body and a yoke structure movable relative to the magnet between a state where a magnetic circuit is formed between the magnet and the metal body and a state where the magnetic circuit is blocked.

According to another aspect of the present invention, a cell transfer system includes a sealed container device which accommodates cells hermetically, a transfer device which transfers the sealed container device, and a receiver device which receives the sealed container device transferred by the transfer device. The sealed container device includes a container body having an opening portion, a lid detachable from the opening portion of the container body, and a sealing structure positioned in a gap formed between the container body and the lid when the lid is inserted into the opening portion of the container body such that the sealing structure maintains a sealed condition of the cells accommodated in the container body, the receiver device includes a receiver body having an opening portion, a door detachable from the opening portion of the receiver body, and a receiver device sealing structure positioned on the receiver body such that the receiver device sealing structure seals a gap formed between the receiver body and the door when the door is inserted into the opening portion of the receiver body, the sealing structure of the sealed container device tightly fits to the receiver body when the opening portion of the sealed container device and the opening portion of the receiver body are positioned to face each other such that the sealing structure seals a gap between the container body and the receiver body, the receiver device sealing structure of the receiver device tightly fits to the lid of the sealed container device such that a gap between the door and the lid is sealed, and the container body of the sealed container device includes a step portion and a metal body positioned at the step portion such that the step portion is positioned to face a peripheral edge portion of the lid on a container-body side, and the lid includes a magnet positioned to face the metal body in the container body and a yoke structure movable relative to the magnet between a state where a magnetic circuit is formed between the magnet and the metal body and a state where the magnetic circuit is blocked.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional front view schematically showing a sealed container according to an embodiment of the present invention;

FIG. 2 is a cross-sectional front view schematically showing the sealed container shown in FIG. 1 in a state where the lid is detached from the container body;

FIG. 3 is a plan view schematically showing an example of a culture plate to be accommodated in the sealed container shown in FIG. 1;

FIG. 4A is a plan view schematically showing the sealed container of FIG. 1 in a state where the lid is fixed to the container body;

FIG. 4B is a plan view schematically showing the sealed container of FIG. 1 in a state where the lid is ready to be detached from the container body;

FIG. 5A is a view schematically illustrating a magnetic circuit in a state shown in FIG. 4A;

FIG. 5B is a view schematically illustrating a magnetic circuit in a state shown in FIG. 4B;

FIG. 6 is a cross-sectional front view schematically showing a state where the sealed container is positioned to open to the side;

FIG. 7 is a cross-sectional front view schematically illustrating the structure for unloading a culture vessel accommodated in the container body;

FIGS. 8A and 8B are views schematically illustrating another example of magnetic circuits in the sealed container shown in FIG. 1;

FIG. 9 is a plan view schematically showing the structure of a cell transfer system that uses the sealed container shown in FIG. 1:

FIG. 10 is an enlarged side view schematically showing the transfer device and an automated cultivation apparatus in the cell transfer system shown in FIG. 9;

FIG. 11A-11D are views schematically illustrating steps for the automated cultivation apparatus shown in FIG. 10 to receive a sealed container from the transfer device;

FIG. 12 is a diagram showing the control system of the automated cultivation apparatus shown in FIG. 10; and

FIG. 13 is an enlarged side view schematically showing the sterilizing apparatus in the cell transfer system shown in FIG. 9.

### DETAILED DESCRIPTION OF THE EMBODIMENTS

The embodiments will now be described with reference to the accompanying drawings, wherein like reference numerals designate corresponding or identical elements throughout the various drawings.

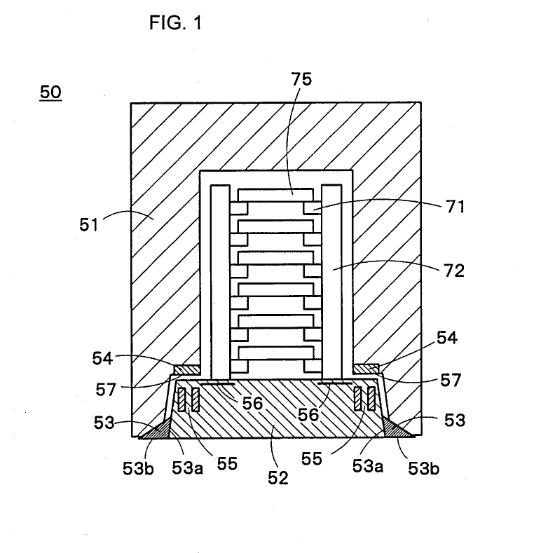

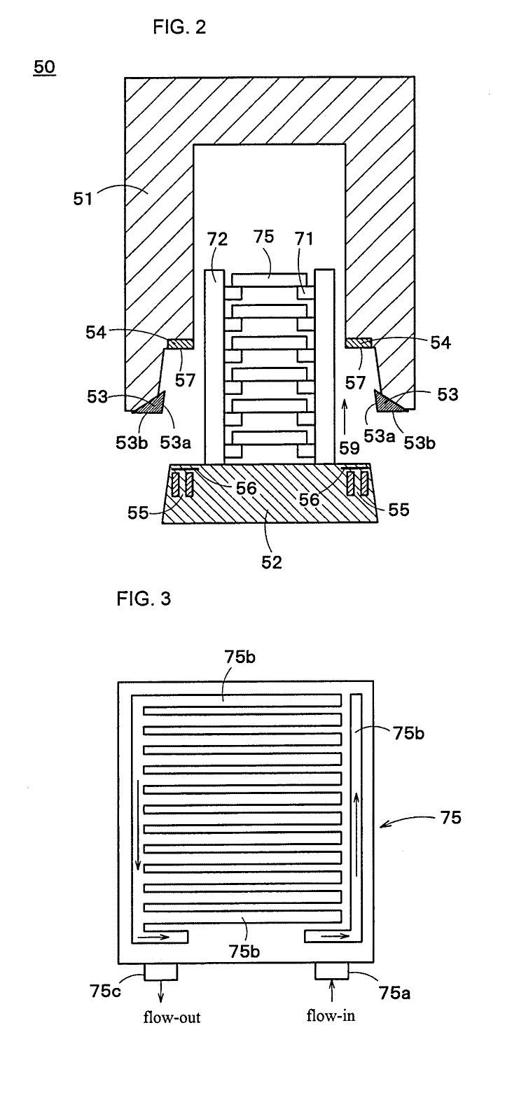

FIG. 1 is a cross-sectional front view schematically showing a sealed container according to an embodiment of the present invention. FIG. 2 is a cross-sectional front view schematically showing a state where the lid is detached from the container body of the sealed container shown in FIG. 1.

The sealed container of the present embodiment is used to hermetically accommodate culture vessels in an automated facility for cultivating various cells, for example, multipotent stem cells such as iPS cells and ES cells, cartilage cells such as marrow stromal cells, dendritic cells and the like.

In the following, the present embodiment is described with reference to an example that mainly uses iPS cells. However, that is not the only option.

As shown in FIGS. 1 and 2, sealed container 50 of the present embodiment is formed with container body 51 having opening 59, lid 52 detachable from opening 59 of container body 51, and sealing member 53 to seal the gap between container body 51 and lid 52.

In the present embodiment, container body 51 is made of resin with its cross section shaped like an upside-down “U” and is open downward as shown in FIG. 2. More specifically, opening 59 of container body 51 is formed to taper with an opening size increasing downward to make it easier to attach/detach lid 52. In the same manner, the side surface of lid 52 is formed to taper with a cross-sectional size decreasing upward to make it easier to attach/detach lid 52.

As shown in FIG. 2, sealing member 53 is made of elastic material shaped like a ring when seen on a plan view, and is tightly fitted to the inner periphery that defines opening 59 of container body 51 in the present embodiment. As shown in FIG. 2, the cross-sectional shape of sealing member 53 is triangular (preferably an obtuse triangle). More specifically, sealing member 53 has first surface (53a) (inner peripheral surface) and second surface (53b) (bottom surface) that is inclined to first surface (53a) at a predetermined obtuse angle as shown in FIG. 2. First surface (53a) of sealing member 53 is positioned to protrude toward the radially inner side of the inner peripheral surface that defines opening 59 of container body 51, whereas second surface (53b) of sealing member 53 is positioned to protrude toward lid 52 (downward) from the edge on the lid 52 side (lower edge) of container body 51.

As shown in FIG. 1, when lid 52 is inserted into opening 59 of container body 51, the side surface of lid 52 does not touch the inner surface of container body 51, but is tightly fitted to first surface (53a) (inner peripheral surface) of sealing member 53. Accordingly, the gap between lid 52 and container body 51 is sealed by sealing member 53.

In the present embodiment, frame 72 is vertically provided on an end surface of lid 52 on the container body 51 side (upper end surface) as shown in FIGS. 1 and 2. Multiple shelves 71 are formed in frame 72 to be stacked vertically with intervals disposed in between, and are each designed to accommodate a closed system culture plate 75 for cell cultivation.

FIG. 3 is a plan view schematically showing an example of culture plate 75. As shown in FIG. 3, culture plate 75 has inlet port (75a), outlet port (75c) and channel (75b) whose one end is connected to inlet port (75a) and the other end is connected to outlet port (75c). As arrows in FIG. 3 show, liquid such as a liquid culture medium flows in through inlet port (75a), passes through channel (75b) and flows out through outlet port (75c). Culture plate 75 is not limited to being a closed system, and may also be an open system culture plate such as a dish or a petri dish.

As shown in FIGS. 1 and 2, container body 51 includes step portion 57 positioned to face the peripheral edge of lid 52 on the container body 51 side (upper edge) and metal body 54 formed at step portion 57.

In the present embodiment, when lid 52 is inserted into opening 59 of container body 51, a gap is formed between step portion 57 and the edge of lid 52 on the container body 51 side as shown in FIG. 1. Accordingly, step portion 57 and the edge of lid 52 on the container body 51 side are prevented from touching each other, and dust caused by such touching is thereby prevented.

Lid 52 includes magnet 55 positioned to correspond to metal body 54 of step portion 57, and yoke member 56 capable of moving relative to magnet 55 to form a state where a magnetic circuit is generated between magnet 55 and metal body 54 and another state where such a magnetic circuit is blocked.

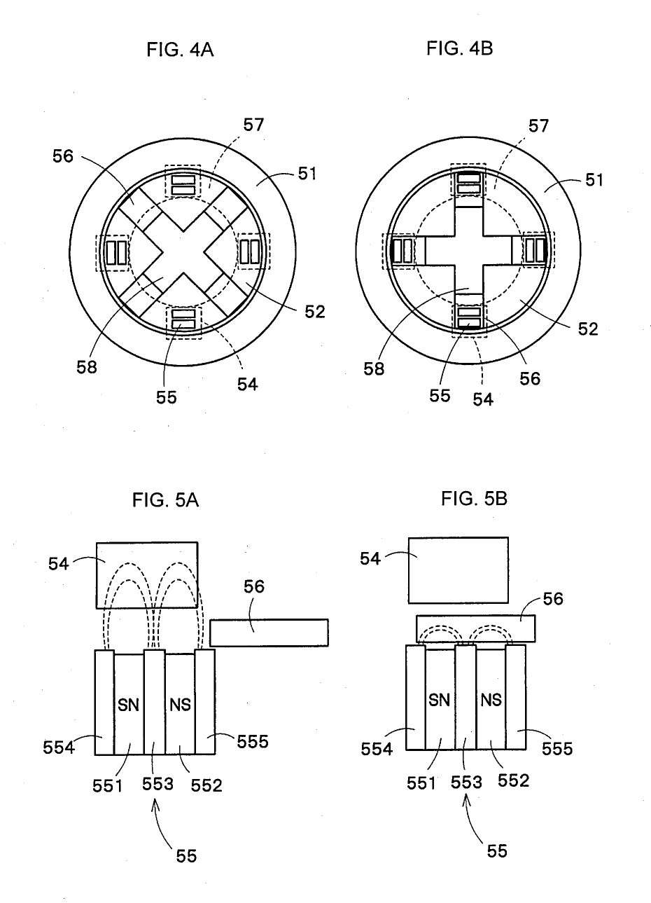

FIG. 4A is a plan view schematically showing sealed container 50 of FIG. 1 in a state where lid 52 is fixed to container body 51 as seen from the lid 52 side. FIG. 4B is a plan view schematically showing sealed container 50 of FIG. 1 in a state where lid 52 is ready to be detached from container body 51 as seen from the lid 52 side. Sealing member 53 is omitted in FIGS. 4A and 4B.

In the present embodiment, multiple (four in the example shown in the drawings) metal bodies 54 are positioned at step portion 57 of container body 51 to have equal intervals in a circumferential direction as shown in FIGS. 4A and 4B. Also, multiple sets (four sets in the example shown in the drawings) of magnets 55 and multiple (four in the example shown in the drawings) yoke members 56 are positioned at the periphery of lid 52 to have equal intervals in a circumferential direction. Yoke members 56 are each positioned between magnet 55 and metal body 54 in a vertical direction (see FIGS. 1 and 2).

In the present embodiment, yoke member 56 is fixed to the tip of each of four arms of yoke support member 58 shaped like a cross in a plan view as shown in FIGS. 4A and 4B. When magnet 55 and metal body 54 are positioned to face each other, and when yoke support member 58 rotates around the vertical center axis, each yoke member 56 is inserted into/pulled out of the space between magnet 55 and metal body 54.

FIG. 5A is a view schematically illustrating a magnetic circuit between magnet 55 and metal body 54 in a state shown in FIG. 4A. FIG. 5B is a view schematically illustrating a magnetic circuit between magnet 55 and metal body 54 in a state shown in FIG. 4B.

In the present embodiment, each magnet 55 has first magnetic component 551 and second magnetic component 552 each having a magnetic pole with the same polarity (the North pole in the example shown in the drawings) formed on a surface facing the other as shown in FIGS. 5A and 5B. First yoke element 553 is disposed between the opposing surfaces of first magnetic component 551 and second magnetic component 552. In addition, second yoke element 554 is disposed to face the surface of first magnetic component 551 opposite first yoke element 553, and third yoke element 555 is disposed to face the surface of second magnetic component 552 opposite first yoke element 553.

As shown in FIG. 5A, when yoke member 56 is not positioned in the space between magnet 55 and metal body 54, magnetic field lines coming out of the N pole of first magnetic component 551 pass through first yoke element 553, metal body 54 and second yoke element 554 in that order, and enter the South pole of first magnetic component 551. Also, magnetic field lines coming out of the N pole of second magnetic component 552 pass through first yoke element 553, metal body 54 and third yoke element 555 in that order, and enter the S pole of second magnetic component 552. Namely, a magnetic circuit is generated between metal body 54 and magnet 55. As a result, metal body 54 is magnetized, and lid 52 is fixed to container body 51 by the magnetic force generated between metal body 54 and magnet 55.

As shown in FIG. 5B, when yoke member 56 is positioned between magnet 55 and metal body 54, magnetic field lines coming out of the N pole of first magnetic component 551 pass through first yoke element 553 and yoke member 56 in that order, then pass through second yoke element 554 without passing through metal body 54, and enter the S pole of first magnetic component 551. Also, magnetic field lines coming out of the N pole of second magnetic component 552 pass through first yoke element 553 and yoke member 56 in that order, then pass through third yoke element 555 without passing through metal body 54, and enter the S pole of second magnetic component 552. Namely, the magnetic circuit between metal body 54 and magnet 55 is blocked by yoke member 56. As a result, magnetic force between metal body 54 and magnet 55 disappears, and lid 52 is ready to be detached from container body 51.

In the present embodiment, frame 72, multiple shelves 71 and multiple culture plates 75 are held on lid 52 as described above. Thus, the magnetic force generated between metal body 54 and magnet 55 is preferred to be sufficiently great; in particular, 10 kgf or greater, for example, is preferred.

The functions of sealed container 50 of the present embodiment are described.

As shown in FIG. 2, multiple culture plates 75 are accommodated in shelves 71 supported on lid 52. Here, as shown in FIG. 4B, yoke member 56 of lid 52 is inserted into the space between magnet 55 and metal body 54, and the magnetic circuit between magnet 55 and metal body 54 is blocked by yoke member 56, as shown in FIG. 5B.

Lid 52, along with multiple culture plates 75, is lifted and is inserted into opening 59 of container body 51. Since opening 59 of container body 51 and lid 52 are both tapered, lid 52 is inserted into opening 59 smoothly. The side surface of lid 52 does not touch the inner surface of container body 51, but is tightly fitted to the inner circumferential surface of sealing member 53. Accordingly, the gap between lid 52 and container body 51 is sealed by sealing member 53.

As shown in FIG. 4A, a robotic arm (not shown) is engaged with yoke support member 58 of lid 52. Then, yoke support member 58 of lid 52 is rotated along with yoke members 56 around the vertical center axis by the robotic arm, and each yoke member 56 is pulled out of the space between magnet 55 and metal body 54. As a result, as shown in FIG. 5A, a magnetic circuit is generated between magnet 55 and metal body 54 so that lid 52 is fixed to container body 51 by magnetic force. As described, multiple culture plates 75 are hermetically accommodated inside sealed container 50.

When the above-described procedures are conducted in reverse order, lid 52 is detached from container body 51 and multiple culture plates 75 are pulled out through opening 59 and unloaded from sealed container 50.

According to the structure of the present embodiment, since the On/Off mechanism of a magnetic circuit is employed as a mechanism of detachable lid 52, no sliding portion is necessary between lid 52 and container body 51. As a result, dust is prevented from occurring in container 50 during the attachment/detachment procedure of lid 52.

According to sealed container 50 of the present embodiment, while yoke members 56 are rotated along with yoke support member 58 to attach/detach lid 52, lid 52 remains still relative to container body 51. Namely, unlike a bayonet method, it is not necessary to rotate lid 52 relative to container body 51. Thus, there is no need to install a complex mechanism, and dust is thereby prevented in the apparatus. Also, little power is needed for attaching/detaching lid 52, and such procedures are easy to automate.

When iPS cells are cultivated, iPS cells may differentiate under stimulation such as vibrations. According to the present embodiment, no sliding portion is necessary to be formed between lid 52 and container body 51. Moreover, since lid 52 remains still relative to container body 51, vibrations generated during attachment/detachment of lid 52 are significantly low. As a result, the container of the embodiment is capable of quietly accommodating cells sensitive to vibrations.

According to the present embodiment, when lid 52 is inserted into opening 59 of container body 51, a gap is formed between step portion 57 and the edge of lid 52 on the container body 51 side as shown in FIG. 1. Thus, step portion 57 and the edge of lid 52 on the container body 51 side are prevented from touching each other and dust caused by such touching is thereby prevented.

According to the present embodiment, since container body 51 is open downward as shown in FIGS. 1 and 2, container body 51 is capable of accommodating multiple stacked culture plates 75 through a smaller opening size than a container body designed to open sideways. Also, multiple culture vessels can be supplied to a cultivation apparatus in one procedure. Thus, risk of contaminants entering container body 51 is slim.

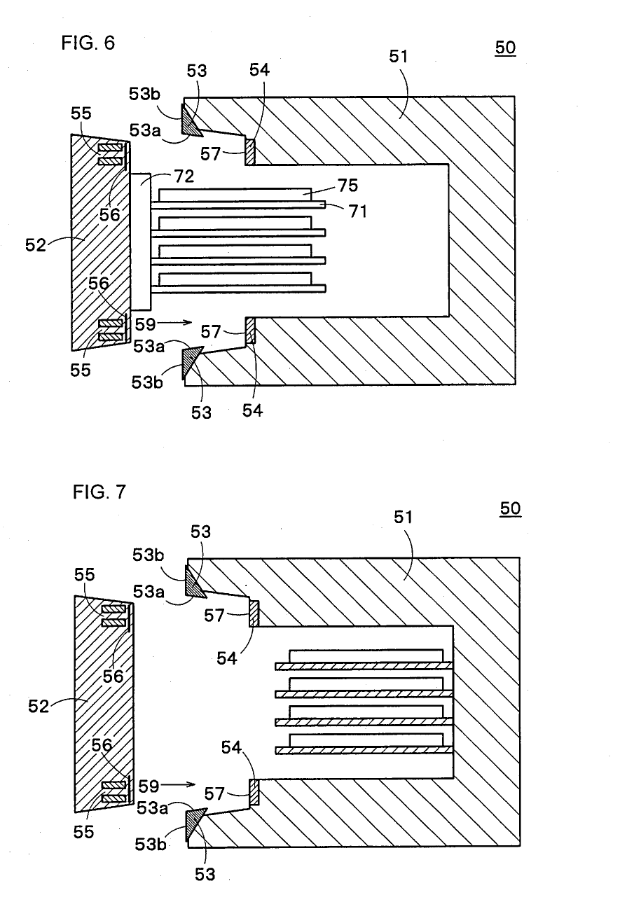

As shown in FIGS. 1 and 2, container body 51 is open downward in the present embodiment. However, that is not the only option. For example, container body 51 may also be open to the side as shown in FIG. 6 or it may be open upward. Alternatively, it may be such a structure that culture vessels accommodated in container body 51 are taken out by lid 52 as shown in FIG. 7. Considering the ease of procedure for accommodating multiple stacked culture plates 75, container body 51 is more preferred to be open downward or upward.

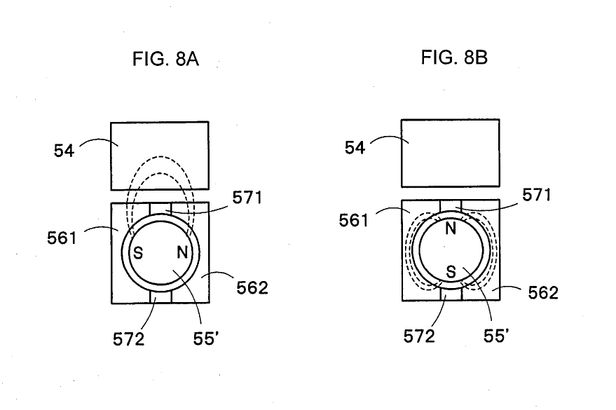

As shown in FIGS. 5A and 5B, magnet 55 remains still relative to metal body 54, whereas yoke member 56 is capable of moving relative to magnet 55 in the present embodiment so that a magnetic circuit is generated between magnet 55 and metal body 54 or such a magnetic circuit is blocked. However, that is not the only option. For example, as shown in FIGS. 8A and 8B, first and second yoke members (561, 562) may be set to remain still relative to metal body 54 while magnet (55′) is capable of moving (rotating) relative to yoke members (561, 562) so that a magnetic circuit is generated between magnet (55′) and metal body 54 or such a magnetic circuit is blocked.

The structure shown in FIGS. 8A and 8B is described below in further detail. Magnet (55′) has a circular cross section and is rotatable around its center axis. Meanwhile, first yoke member 561 is positioned to face the left side of magnet (55′) within a predetermined angular range, and second yoke member 562 is positioned to face the right side of magnet (55′) within a predetermined angular range. In addition, nonmagnetic members (571, 572) are disposed between first yoke member 561 and second yoke member 562 so as to block magnetic coupling of the yoke members.

As shown in FIG. 8A, when the S pole of magnet (55′) faces first yoke member 561 and the N pole faces second yoke member 562, magnetic field lines coming out of the N pole of magnet (55′) pass through second yoke member 562, metal body 54 and first yoke member 561 in that order and enter the S pole of magnet (55′). Namely, a magnetic circuit is generated between metal body 54 and magnet (55′) via first and second yoke members (561, 562). Accordingly, metal body 54 and first and second yoke members (561, 562) are magnetized, and lid 52 is fixed to container body 51 by the magnetic force generated between metal body 54 and first and second yoke members (561, 562).

As shown in FIG. 8B, when magnet (55′) is moved (rotated) relative to first and second yoke members (561, 562) so that the N pole and the S pole of magnet (55′) face nonmagnetic members (571, 572) respectively, magnetic field lines coming out of the N pole of magnet (55′) pass through first yoke member 561 or second yoke member 562 and enter the S pole of magnet (55′) without passing through metal body 54. Namely, the magnetic circuit between metal body 54 and magnet (55′) is blocked by first and second yoke members (561, 562). As a result, magnetic force acting on metal body 54 disappears, and lid 52 is ready to be detached from container body 51.

The following is a description of a cell transfer system (a cell transfer system according to an embodiment of the present invention) using sealed container 50 described above.

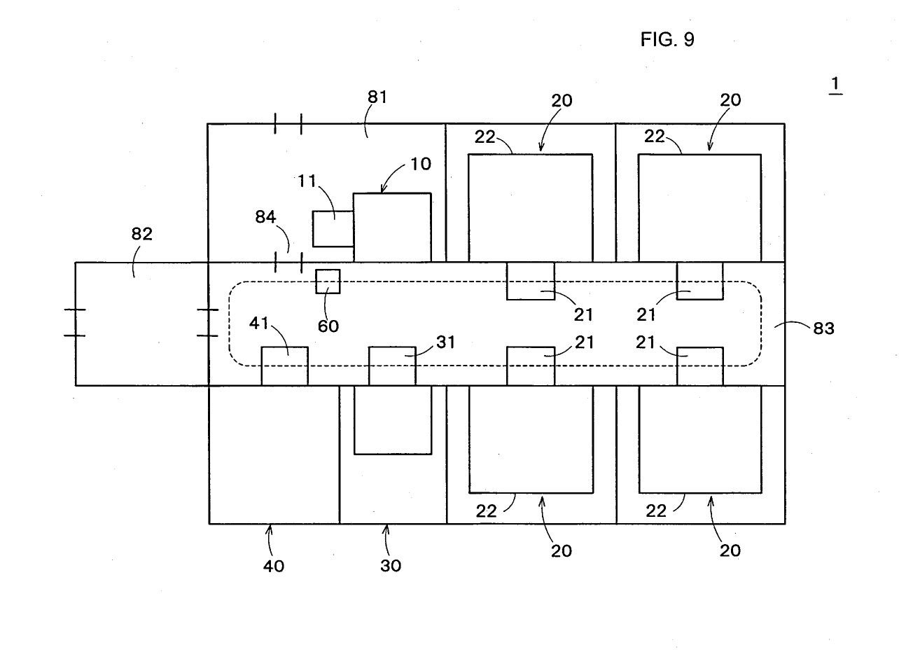

FIG. 9 is a plan view schematically showing the structure of cell transfer system 1 according to the present embodiment.

As shown in FIG. 9, cell transfer system 1 of the present embodiment is equipped with transfer device 60 to transfer sealed container 50 that hermetically accommodates cell vessels or the like for cell cultivation, sterilizing apparatus 10 to sterilize the inside of sealed container 50, multiple (four in the example shown here) automated cultivation apparatuses 20 each designed to unload culture vessels from sealed container 50 and to cultivate cells in its internal portion. Sealed container 50 is capable of loading culture vessels with cells to be cultivated, empty culture vessels, culture vessels with cultivated cells, unused material for cell cultivation, used material for cell cultivation, and the like. As described above, the present embodiment is described with reference to iPS cells. Thus, automated cultivation apparatus 20 is used for cultivating iPS cells automatically. Automated cultivation apparatus 20 may also be used for cell differentiation.

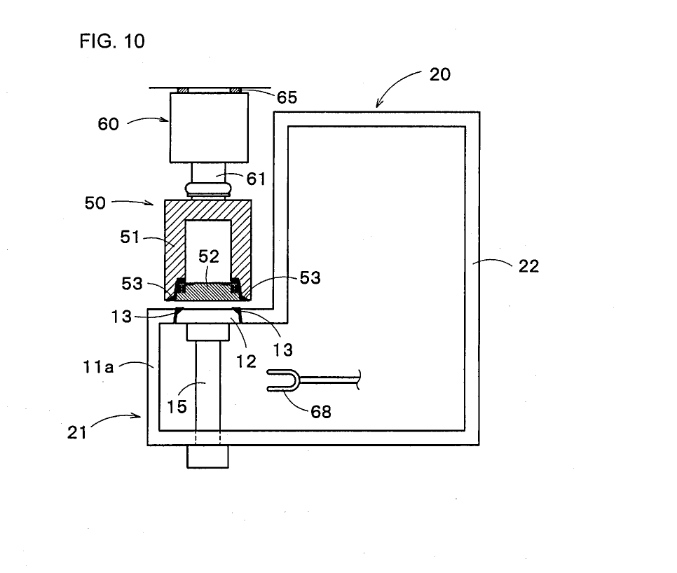

FIG. 10 is an enlarged side view of transfer device 60 and automated iPS cell cultivation apparatus 20.

As shown in FIG. 10, transfer device 60 of the present embodiment has holder device 61 to hold sealed container 50 by hanging it downward, and is movable along rail 65 provided on the ceiling. Transfer device 60 is capable of vertically lifting/lowering sealed container 50 held by holding device 61.

Automated iPS cell cultivation apparatus 20 of the present embodiment is positioned under rail 65, and has receiver device 21 to receive sealed container 50 from transfer device 60 and casing 22 connected to receiver device 21. Transfer arm 68 is provided inside casing 22.

As shown in FIG. 10, receiver device 21 is formed with receiver body (11a) having an opening, door 12 detachable from the opening of receiver body (11a), and receiver-side sealing member 13 provided for receiver body (11a) to seal the gap between receiver body (11a) and door 12.

In the present embodiment, receiver body (11a) is open upward as shown in FIG. 10. More specifically, the opening of receiver body (11a) is formed to taper with an opening size increasing downward to make it easier to attach/detach door 12. In the same manner, the side surface of door 12 is formed to taper with an opening size decreasing upward to make it easier to attach/detach door 12.

As shown in FIG. 10, receiver-side sealing member 13 is made of elastic material shaped like a ring when seen on a plan view, and is tightly fitted to the inner periphery that defines the opening of receiver body (11a) in the present embodiment. As shown in FIG. 10, the cross-sectional shape of receiver-side sealing member 13 is triangular (preferably an obtuse triangle). More specifically, receiver-side sealing member 13 has a first surface (outer peripheral surface) and a second surface (upper surface) that is inclined to the first surface at a predetermined obtuse angle. The first surface of receiver-side sealing member 13 is positioned to protrude toward the radially inner side of the inner peripheral surface which defines the opening of receiver body (11a), whereas the second surface of receiver-side sealing member 13 is positioned to protrude upward from the upper edge of receiver body (11a).

As shown in FIG. 10, when door 12 is inserted into the opening of receiver body (11a), the side surface of door 12 does not touch the inner surface of receiver body (11a) but is tightly fitted to the first surface (outer peripheral surface) of receiver-side sealing member 13. Accordingly, the gap between door 12 and receiver body (11a) is sealed by receiver-side sealing member 13.

In the present embodiment, a lifting device 15 is connected to the lower end of door 12 as shown in FIG. 10 so that door 12 is supported at a desired height by lifting device 15. When door 12 inserted into the opening of receiver body (11a) is moved downward by lifting device 15, the opening of receiver body (11a) will be opened.

In the present embodiment, when sealed container 50 and receiver device 21 are positioned to face each other, container-side sealing member 53 is tightly fitted to receiver body (11a) to seal the gap between container body 51 and receiver body (11a), while receiver-side sealing member 13 is tightly fitted to lid 52 to seal the gap between door 12 and lid 52.

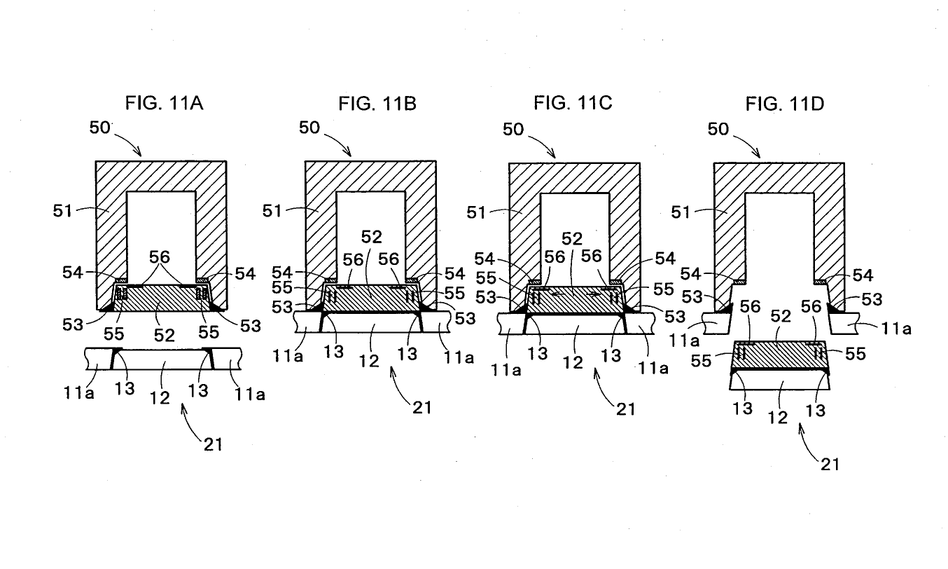

By referring to FIG. 11A˜11D, the process is described in detail as to how receiver device 21 of automated iPS cell cultivation apparatus 20 receives sealed container 50 from transfer device 60.

As shown in FIG. 11A, sealed container 50 is transferred by transfer device 60 and aligned so that the opening of sealed container 50 is positioned to face the opening of receiver device 21. Here, lid 52 is inserted into the opening of container body 51, and the gap between container body 51 and lid 52 is sealed by container-side sealing member 53. Also, door 12 is inserted into the opening of receiver body (11a) and the gap between receiver body (11a) and door 12 is sealed by receiver-side sealing member 13.

As shown in FIG. 11B, sealed container 50 is moved vertically downward by transfer device 60. As a result, the bottom of container-side sealing member 53 is tightly fitted to the upper surface of receiver body (11a) to seal the gap between container body 51 and receiver body (11a), while the upper surface of receiver-side sealing member 13 is tightly fitted to the bottom of lid 52 to seal the gap between door 12 and lid 52. At that time, the corner formed between the inner circumferential surface and the bottom of container-side sealing member 53 is tightly fitted to the corner formed between the outer circumferential surface and the upper surface of receiver-side sealing member 13.

As shown in FIG. 11C, a robotic arm (not shown) operates to move yoke member 56 relative to magnet 55 so that the magnetic circuit between magnet 55 and metal body 54 is blocked by yoke member 56. Accordingly, lid 52 is ready to be detached from container body 51.

As shown in FIG. 11D, door 12 along with lid 52 is moved downward by lifting device 15. As a result, the opening of receiver body (11a) is connected to the opening of container body 51. At that time, since the gap between container body 51 and receiver body (11a) is sealed by container-side sealing member 53, contaminants such as dust and viruses existing in the outer space of container body 51 and receiver body (11a) are prevented from entering the inner space. Also, since the gap between door 12 and lid 52 is sealed by receiver-side sealing member 13, contaminants such as dust and viruses attached to the upper portion of door 12 or the lower portion of lid 52 are prevented from entering the inner space of container body 51 and receiver body (11a).

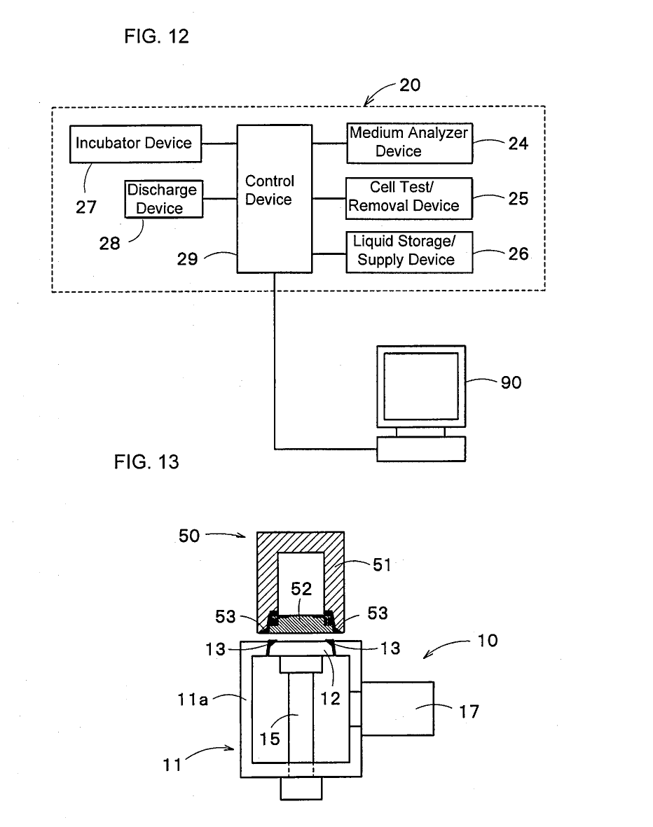

FIG. 12 is a diagram showing how to control automated iPS cell cultivation apparatus 20.

As shown in FIG. 12, automated iPS cell cultivation apparatus 20 is equipped with medium analyzer device 24 to analyze the liquid medium components that change as iPS cells are cultivated; cell test/removal device 25 to test iPS cells and remove undesired iPS cells; liquid storage/supply device 26 to store and supply such liquid that contains liquid medium and proteolytic enzymes; incubating device 27 to hold culture plate 75 and automatically adjust any one—or two or more—of temperature, humidity and gas concentration levels; and discharge device 28 to discharge downward from casing 22 waste liquids used in automated iPS cell cultivation apparatus 20, for example, a used liquid medium, used cleaning liquid, used agent or the like.

Operations of automated iPS cell cultivation apparatus 20 are described below.

Liquid storage/supply device 26 supplies a liquid medium to culture plate 75 from inlet port (75a) of culture plate 75 so that the used liquid medium in culture plate 75 is replaced automatically with a new liquid medium. Cell test/removal device 25 selectively removes undesired iPS cells from the extracellular matrix (ECM) provided at the bottom of culture plate 75, based on the information of iPS cells. After that, liquid storage/supply device 26 supplies a liquid medium into culture plate 75 from inlet port (75a) of culture plate 75 so that undesired floating iPS cells are discharged from culture plate 75. Also, liquid storage/supply device 26 properly supplies a proteolytic enzyme into culture plate 75 from inlet port (75a) of culture plate 75 so that iPS cells are removed from the ECM provided on the bottom of culture plate 75. Then, liquid storage/supply device 26 supplies liquid medium into culture plate 75 from inlet port (75a) of culture plate 75 so that floating iPS cells are discharged from culture plate 75. The discharged iPS cells are diluted to make a suspension liquid, which is then placed (disseminated) in different multiple culture plates 75. As described, automated iPS cell cultivation apparatus 20 automatically performs subculturing of iPS cells. Examples of a method for selectively removing iPS cells from culture plate 75 are irradiating ultrasonic waves and light beams on iPS cells, applying physical force from outside culture plate 75 and the like. When such a method is employed, a proteolytic enzyme may be used as well.

The internal temperature of automated iPS cell cultivation apparatus 20 is adjusted by incubator device 27 to be approximately 37° C., for example. Also, the gas concentration level inside automated iPS cell cultivation apparatus 20 is adjusted by incubator device 27 by properly adding CO₂ to the air. If necessary, the humidity may be adjusted by incubator device 27 to be approximately 100 percent.

As shown in FIG. 12, automated iPS cell cultivation apparatus 20 includes control device 29 to communicate with and control each of medium analyzer apparatus 24, cell test/removal device 25, liquid storage/supply device 26, incubator device 27 and discharge device 28. In particular, control device 29 is set in outer apparatus 90 such as a computer.

FIG. 13 is an enlarged side view schematically showing sterilizing apparatus 10.

As shown in FIG. 13, sterilizing apparatus 10 is provided in delivery area 81 (see FIG. 9), and includes receiver device 11 which receives sealed container 50 from an operator and sterilizing gas supply device 17 to sterilize the inside of sealed container 50 received by receiver device 11 by supplying sterilizing gas such as hydrogen peroxide gas or hot gas. In another example of sterilizing apparatus 10, an irradiation device is provided instead of sterilizing gas supply device 17 to sterilize the inside of sealed container 50 received by receiver device 11 by irradiating γ rays or ultraviolet rays. When the liquid medium contains protein or the like that can be damaged by γ rays or ultraviolet rays, it is preferred to sterilize using hydrogen peroxide gas or hot gas. The structure of receiver device 11 in sterilizing apparatus 10 is the same as that of receiver device 21 in aforementioned automated iPS cell cultivation apparatus 20 except that it is provided in delivery area 81 and receives sealed container 50 from an operator. Thus, its detailed description is omitted here.

In the present embodiment, receiver device 11 of sterilizing apparatus 10 is provided in delivery area 81 as shown in FIG. 9. However, that is not the only option, and receiver device 11 may also be provided under rail 65 in transfer area 81, the same as receiver device 21 of automated iPS cell cultivation apparatus 20. In such a case, receiver device 11 receives sealed container 50 from transfer device 60.

The cell transfer system 1 of the present embodiment further includes analyzer apparatus 30 to receive the cells cultivated in automated cultivation apparatus 20 at predetermined timing and to test the cells, and freeze-storage apparatus 40 to freeze-store iPS cells cultivated in automated cultivation apparatus 20.

As shown in FIG. 9, analyzer apparatus 30 and freeze-storage apparatus 40 are provided with receiver devices 31 and 41 respectively which are positioned under rail 65 and receive sealed container 50 from transfer device 60. The structures of receiver device 31 in analyzer apparatus 30 and receiver device 41 in freeze-storage apparatus 40 are approximately the same as that of receiver device 21 in aforementioned automated cultivation apparatus 20. Thus, their detailed descriptions are omitted here.

The operations of cell transfer system 1 of the present embodiment are described below.

As shown in FIG. 9, one or multiple culture plates 75 with stored iPS cells are accommodated for example, manually by an operator, into sealed container 50 in delivery area 81.

Sealed container 50 with stored culture plates 75 is transferred manually to receiver device 11 of sterilizing device 10 by an operator, for example.

In receiver device 11 of sterilizing apparatus 10, the transfer procedures described above with reference to FIG. 11A˜11D that are conducted by transfer device 60 are replaced with manual procedures and conducted in that order by an operator. Accordingly, the opening of receiver body (11a) and the opening of container body 51 are connected to each other, while contaminants such as dust and viruses are prevented from entering the inner space of container body 51 and receiver body (11a). Then, sterilizing gas is supplied from sterilizing gas supply device 17 into receiver device 11 (see FIG. 13) so that the inner portions of receiver body (11a) and container body 51 are sterilized.

Next, the transfer procedures shown in FIG. 11A˜11D that are conducted by transfer device 60 are replaced with manual procedures and conducted in reverse order by an operator. Accordingly, the opening of container body 51 is sealed by lid 52 and container-side sealing member 53 and the opening of receiver body (11a) is sealed by door 12 and receiver-side sealing member 13, while contaminants such as dust and viruses are prevented from entering the inner space of container body 51 and receiver body (11a).

As shown in FIG. 9, sealed container 50 in a tightly closed condition is placed manually by an operator, for example, in loading area 84 connected to transfer area 83. Loading area 84 has double doors, for example. When sealed container 50 is placed in loading area 84, the first door positioned on the delivery-area 81 side is opened (the door on the transfer-area 83 side is closed) to guide sealed container 50 between the first door and the second door, and then the first door is closed. Here, the outer surface of sealed container 50 is sterilized, if necessary. Then, the second door is opened so that sealed container 50 is received by transfer device 60 in transfer area 83.

Next, as shown in FIG. 9, sealed container 50 is transferred by transfer device 60 to receiver device 21 of automated iPS cell cultivation apparatus 20.

In receiver device 21 of automated iPS cell cultivation apparatus 20, the steps described with reference to FIG. 11A˜11D are conducted in that order, and the opening of receiver body (11a) and the opening of container body 51 are connected to each other while contaminants such as dust and viruses are prevented from entering the inner space of container body 51 and receiver body (11a). Next, culture plates 75 are taken from sealed container 50 to automated iPS cell cultivation apparatus 20.

As described above, iPS cells loaded into automated iPS cell cultivation apparatus 20 are cultivated in the automated iPS cell cultivation apparatus 20. During the cultivation process, the liquid medium is automatically replaced as needed, and iPS cells are automatically subcultured. Any one—or two or more—of temperature, humidity and gas concentration levels may be adjusted by incubating device 27. Here, automated iPS cell cultivation apparatus 20 of the present embodiment is exclusively assigned to each provider of the cells. For example, when iPS cells provided by person “A” are being cultivated in one automated iPS cell cultivation apparatus 20, other iPS cells provided by someone else or iPS cells of animals or the like will not be cultivated in the same apparatus 20.

Part of iPS cells cultivated in automated iPS cell cultivation apparatus 20 is taken from automated iPS cell cultivation apparatus 20 to sealed container 50 and transferred by transfer device 60 to receiver device 31 of iPS cell analyzer apparatus 30. Then, the cultivation state (the state of DNA, for example) is analyzed in iPS cell analyzer apparatus 30. The test in iPS cell analyzer apparatus 30 is usually a destructive inspection different from the test conducted inside automated iPS cell cultivation apparatus 20. Thus, the iPS cells used for analysis will be destroyed without being returned to automated iPS cell cultivation apparatus 20.

When cultivation of iPS cells is finished in automated iPS cell cultivation apparatus 20, one or multiple culture plates 75 with stored iPS cells are accommodated on multiple shelves 71 supported on lid 52 of sealed container 50. Then, the steps shown in FIG. 11A˜11D are conducted in reverse order. Accordingly, the opening of container body 51 is sealed by lid 52 and container-side sealing member 53, while the opening of receiver body (11a) is sealed by door 12 and receiver-side sealing member 13, so that contaminants such as dust and viruses are prevented from entering the inner space of container body 51 and receiver body (11a). Hermetically sealed container 50 is received by transfer device 60 and is hung downward.

When cultivated iPS cells are freeze-stored, sealed container 50 with cultivated iPS cells is transferred by transfer device 60 to receiver device 41 of freeze-storage apparatus 40. In freeze-storage apparatus 40, culture plate 75 is taken out from sealed container 50 so that iPS cells in culture plate 75 are stored in freeze-storage apparatus 40.

To ship iPS cells stored in freeze-storage apparatus 40, culture plate 75 with iPS cells is accommodated in sealed container 50, and the sealed container 50 is transferred by transfer device 60 to shipping area 82. When sealed container 50 is transferred to shipping area 82, iPS cells are shipped as they are stored in sealed container 50 or in culture plate 75 after being taken out of sealed container 50.

When the shipment recipient of iPS cells (hospital or factory) is located adjacent to or in the neighborhood of aforementioned cell transfer system 1, there is no need to freeze-store iPS cells. In such a case, culture plate 75 with iPS cells taken out of automated iPS cell cultivation apparatus 20 is accommodated in sealed container 50 and transferred to shipping area 82 by transfer device 60 without being frozen. Then, iPS cells are shipped from shipping area 82 to such an adjacent or neighboring shipment recipient while they are stored in sealed container 50 or in culture plate 75 after being taken out of sealed container 50.

In cell transfer system 1 of the present embodiment, the inside of sealed container 50 and the inside of automated iPS cell cultivation apparatus 20 are controlled to keep a relatively high degree of cleanliness. By so setting, only the space affecting cell cultivation is controlled to have a high degree of cleanliness, and the cost of such control management is low. Also, since spaces are divided into a relatively small size, only the space that requires sterilization can be isolated and sterilized. Thus, maintenance procedures are simplified when operating cell transfer system 1.

Although delivery area 81 and shipping area 82 where operators are present have a relatively low degree of cleanliness compared with transfer area 83, cells are handled by maintaining a high degree of cleanliness when sealed container 50 of the embodiment is used.

Subsequent to cultivation of iPS cells, any cells that are differentiated from iPS cells may also be cultivated using the same apparatus.

In the present application, “sterilized” indicates not only a state where microorganisms are completely sterilized, but also a state where microorganisms that may adversely affect cultivation of cells are kept under an appropriate number.

In recent years, regenerative medicine has been researched and developed to artificially produce desired tissues and organs by cultivating cells. Cell cultivation is conducted in a cell culture facility that satisfies predetermined standards such as good manufacturing practices (GMP). In such a cell cultivation facility, sterilization control and operations under sterile conditions are necessary. For example, cell processing centers (CPC) are an example of such a facility.

Meanwhile, cell cultivation procedures have been intended to be automated to a certain degree.

To maintain the sterilized state inside a carrier case and cultivation apparatus when a culture vessel is loaded, sterilization control of the outer space of the cultivation apparatus and carrier case is also necessary. In a facility that handles cells such as iPS cells subsequently to be returned to a human body or the like, sterilization control is significantly strict, and the costs of the facility and maintenance are high.

When a bayonet method is employed for a detachable mechanism for a lid, a sliding portion is formed between the lid and the container body. In such a case, dust is generated in the sliding portion every time the lid is attached/detached. Thus, it is hard to maintain a high degree of cleanliness in the container. Also, if a bayonet method is employed as a detachable lid mechanism, the lid is rotated relative to the container body when the lid is attached/detached from the container. Such a mechanism is hard to automate.

The sealed container according to an embodiment of the present invention and the cell transfer system according to another embodiment are easy to automate for attaching/detaching the lid, while dust is prevented from occurring in a container during attachment/detachment of the lid.

The sealed container according to an embodiment of the present invention is characterized by having a container body with an opening, a lid detachable from the opening of the container body, and a sealing member to seal the gap between the container body and the lid. The container body includes a step portion positioned to face the peripheral edge of the lid on the container body side, and a metal body provided at the step portion. The lid includes a magnet positioned to correspond to the metal body of the step portion, and a yoke member capable of moving relative to the magnet to form a state where a magnetic circuit is generated between the magnet and the metal body and another state where such a magnetic circuit is blocked.

The sealed container according to an embodiment of the present invention is usually used to accommodate cells hermetically. According to the embodiment, when a magnetic circuit is generated between a magnet and a metal body, the lid is fixed to the container body by magnetic force, and when the magnetic circuit is blocked, the lid is ready to be detached from the container body. Since the On/Off of a magnetic circuit is employed for a detachable mechanism of a lid, no sliding portion is needed between the lid and the container body. Thus, dust is prevented from occurring in the container during attachment/detachment of the lid. Also, unlike a bayonet method, the attachment/detachment procedure does not require rotating the lid relative to the container body, and thus is easy to automate. In addition, vibrations during the lid attachment/detachment procedure are smaller than those of a bayonet method. Thus, cultivated cells, for example, that are sensitive to vibrations can be accommodated without causing damage to the cells.

It is preferred that a gap be formed between the step portion and the container-side edge of a lid when the lid is inserted into the opening of the container body. Such a structure prevents dust from being caused when the step portion touches the edge of the lid on the container body side.

The container body is preferred to open downward. When the container body is open downward, such a structure is capable of accommodating culture plates through a smaller opening size than in a structure that opens to the side when multiple stacked culture plates for cell culture are accommodated in a sealed container.

The cell transfer system according to an embodiment of the present invention is equipped with a transfer device to transfer a sealed container for hermetically accommodating cells, and a receiver device to receive the sealed container transferred by the transfer device. The sealed container is formed with a container body having an opening, a lid detachable from the opening of the container body, and a container-side sealing member to seal the gap between the container body and the lid. The receiver device is formed with a receiver body having an opening, a door detachable from the opening of the receiver body, and a receiver-side sealing member to seal the gap between the receiver body and the door. When the openings of the sealed container and the receiver device are positioned to face each other, the container-side sealing member is tightly fitted to the receiver body to seal the gap between the container body and the receiver body, and the receiver-side sealing member is tightly fitted to the lid to seal the gap between the door and the lid. The container body includes a step portion positioned to face the peripheral edge of the lid on the container body side, and a metal body formed at the step portion. The lid includes a magnet positioned to correspond to the metal body of the step portion, and a yoke member movable relative to the magnet to form a state where a magnetic circuit is generated between the magnet and the metal body and another state where such a magnetic circuit is blocked.

According to the cell transfer system of an embodiment of the present invention, when a magnetic circuit is generated between a magnet and a metal body in the sealed container, the lid is fixed to the container body by magnetic force, and when the magnetic circuit is blocked, the lid is ready to be detached from the container body. Since the On/Off mechanism of a magnetic circuit is employed for the lid detachable mechanism, a sliding portion is not necessary to be formed between the lid and the container body. Thus, dust is prevented from occurring in the container during attachment/detachment of the lid. In addition, unlike a bayonet method, the attachment/detachment procedure does not require rotating the lid relative to the container body, and thus is easy to automate. Moreover, vibrations during the lid attachment/detachment procedure are smaller than those of a bayonet method. Thus, cultivated cells, for example, that are sensitive to vibrations can be accommodated without causing damage to the cells.

It is preferred that a gap be formed between the step portion and the container-side edge of a lid when the lid of the sealed container is inserted into the opening of the container body. Such a structure prevents dust from being caused when the step portion touches the edge of the lid on the container body side.

The container body of the sealed container is preferred to open downward and the receiver body of the receiver device is preferred to open upward. Since the container body is open downward and the receiver body is open upward, such a structure is capable of accommodating culture plates through a smaller opening size than in a structure where both container body and receiver body are open to the side when multiple stacked culture plates for cell culture are accommodated in a sealed container.

More specifically, the receiver device is provided in an automated cultivation apparatus that takes out cells from the sealed container and cultivates the cells.

Alternatively, the receiver device may be that of the sterilizing apparatus to sterilize the inside of the sealed container with stored cells.

Using the sealed container according to an embodiment of the present invention and the cell transfer system according to another embodiment, it is easier to automate the attachment/detachment procedure of a lid, and dust caused during the attachment/detachment procedure is prevented in the container.

Obviously, numerous modifications and variations of the present invention are possible in light of the above teachings. It is therefore to be understood that within the scope of the appended claims, the invention may be practiced otherwise than as specifically described herein.

What is claimed is:

1. A sealed container device for hermetically accommodating cells, comprising:
a container body having an opening portion;
a lid configured to detach from the opening portion of the container body; and
a sealing structure positioned in a gap formed between the container body and the lid when the lid is inserted into the opening portion of the container body such that the sealing structure maintains a sealed condition of the cells accommodated in the container body,
wherein the container body includes a step portion and a metal body positioned at the step portion such that the step portion is positioned to face a peripheral edge portion of the lid on a container-body side, and the lid includes a magnet positioned to face the metal body in the container body and a yoke structure configured to move relative to the magnet between a state where a magnetic circuit is formed between the magnet and the metal body and a state where the magnetic circuit is blocked.

2. A sealed container device according to claim 1, wherein the sealing structure is positioned on an edge portion of an inner peripheral portion defining the opening portion of the container body.

3. A sealed container device according to claim 1, wherein the sealing structure has a triangle cross-section shape.

4. A sealed container device according to claim 1, wherein the lid and the container body are configured such that when the lid is inserted into the opening portion of the container body, a gap is formed between the step portion of the container body and an edge portion of the lid on the container-body side.

5. A sealed container device according to claim 1, wherein the container body has an upper end portion and a lower end portion, and the opening portion of the container body is formed in the lower end portion of the container body.

6. A sealed container device according to claim 2, wherein the sealing structure has a triangle cross-section shape.

7. A sealed container device according to claim 2, wherein the lid and the container body are configured such that when the lid is inserted into the opening portion of the container body, a gap is formed between the step portion of the container body and an edge portion of the lid on the container-body side.

8. A sealed container device according to claim 2, wherein the container body has an upper end portion and a lower end portion, and the opening portion of the container body is formed in the lower end portion of the container body.

9. A sealed container device according to claim 6, wherein the lid and the container body are configured such that when the lid is inserted into the opening portion of the container body, a gap is formed between the step portion of the container body and an edge portion of the lid on the container-body side.

10. A sealed container device according to claim 1, wherein the container body is configured to accommodate a plurality of cell culture plates in the sealed condition inside the container body, when the lid is inserted into the opening portion of the container body.

11. A cell transfer system, comprising:
a sealed container device configured to accommodate cells hermetically;
a transfer device configured to transfer the sealed container device; and
a receiver device configured to receive the sealed container device transferred by the transfer device,
wherein the sealed container device includes a container body having an opening portion, a lid configured to detach from the opening portion of the container body, and a sealing structure positioned in a gap formed between the container body and the lid when the lid is inserted into the opening portion of the container body such that the sealing structure maintains a sealed condition of the cells accommodated in the container body, the receiver device includes a receiver body having an opening portion, a door configured to detach from the opening portion of the receiver body, and a receiver device sealing structure positioned on the receiver body such that the receiver device sealing structure seals a gap formed between the receiver body and the door when the door is inserted into the opening portion of the receiver body, the sealing structure of the sealed container device is configured to tightly fit to the receiver body when the opening portion of the sealed container device and the opening portion of the receiver body are positioned to face each other such that the sealing structure seals a gap between the container body and the receiver body, the receiver device sealing structure of the receiver device is configured to tightly fit to the lid of the sealed container device such that a gap between the door and the lid is sealed, and the container body of the sealed container device includes a step portion and a metal body positioned at the step portion such that the step portion is positioned to face a peripheral edge portion of the lid on a container-body side, and the lid includes a magnet positioned to face the metal body in the container body and a yoke structure configured to move relative to the magnet between a state where a magnetic circuit is formed between the magnet and the metal body and a state where the magnetic circuit is blocked.

12. A cell transfer system according to claim 11, wherein the lid and container body of the sealed container device are configured such that when the lid is inserted into the opening portion of the container body, a gap is formed between the step portion of the container body and an edge portion of the lid on the container-body side.

13. A cell transfer system according to claim 11, wherein the container body of the sealed container device has an upper end portion and a lower end portion, the opening portion of the container body is formed in the lower end portion of the container body, the receiver body of the receiver device has an upper end portion and a lower end portion, and the opening portion of the receiver body is formed in the upper end portion of the receiver body.

14. A cell transfer system according to claim 11, wherein the receiver device is a receiver device of an automated cultivation apparatus configured to culture the cells received from the sealed container device.

15. A cell transfer system according to claim 11, wherein the receiver device is a receiver device of a sterilizing apparatus configured to sterilize an inside of the sealed container device accommodating the cells.

16. A cell transfer system according to claim 12, wherein the container body of the sealed container device has an upper end portion and a lower end portion, the opening portion of the container body is formed in the lower end portion of the container body, the receiver body of the receiver device has an upper end portion and a lower end portion, and the opening portion of the receiver body is formed in the upper end portion of the receiver body.

17. A cell transfer system according to claim 12, wherein the receiver device is a receiver device of an automated cultivation apparatus configured to culture the cells received from the sealed container device.

18. A cell transfer system according to claim 12, wherein the receiver device is a receiver device of a sterilizing apparatus configured to sterilize an inside of the sealed container device accommodating the cells.

19. A cell transfer system according to claim 16, wherein the sealing structure of the sealed container device is positioned on an edge portion of an inner peripheral portion defining the opening portion of the container body.

20. A cell transfer system according to claim 11, wherein the container body of the sealed container device is configured to accommodate a plurality of cell culture plates in the sealed condition inside the container body, when the lid of the sealed container device is inserted into the opening portion of the container body.
